(19) United States
(12) Patent Application Publication
(10) Pub. No.: US 2023/0166857 A1
(43) Pub. Date: Jun. 1, 2023

(54) FINAL TAKEOFF SPEED DETERMINATION FOR AN AIRCRAFT

(71) Applicant: Raytheon Technologies Corporation, Farmington, CT (US)

(72) Inventors: David Wasselin, Longmeadow, MA (US); Nancy Poisson, Avon, CT (US); Brian V. Winebrenner, Vernon, CT (US); Bradley C. Schafer, Ellington, CT (US); Ramesh Rajagopalan, Glastonbury, CT (US)

(21) Appl. No.: 18/071,138

(22) Filed: Nov. 29, 2022

Related U.S. Application Data
(60) Provisional application No. 63/283,775, filed on Nov. 29, 2021.

(51) Int. Cl. B64D 31/06; B64D 45/00

(52) U.S. Cl. CPC B64D 31/06; B64D 45/00

(57) ABSTRACT

A system of an aircraft includes one or more gas turbine engines and a controller. The controller is configured to detect a pre-takeoff condition of the aircraft and determine one or more control parameters for one or more current conditions at a target location of the aircraft. The controller is further configured to determine a final takeoff speed of the one or more gas turbine engines based on the one or more control parameters. At least one of the one or more gas turbine engines is controlled to accelerate to the final takeoff speed after transitioning from the pre-takeoff condition to a takeoff condition.

### CROSS-REFERENCE TO RELATED APPLICATIONS

This application claims the benefit of U.S. Provisional Application No. 63/283,775 filed Nov. 29, 2021, the disclosure of which is incorporated herein by reference in its entirety.

### BACKGROUND

Exemplary embodiments of the present disclosure pertain to the art of aircraft control and, more particularly, to a method and a system for final takeoff speed determination for an aircraft.

Prior to takeoff of an aircraft, a targeted engine speed is typically determined manually through cross referencing multiple sources of information and tables. This process can support setting the targeted engine speed to a lower speed for thrust reduction and fuel savings while supporting safe aircraft operation. The use of multiple sources and tables may result in imprecise settings as the tables may not include enough detail to support higher precision. Further, the tables may incorporate excessively conservative values to account for time gaps from when the information is determined prior to pushback of the aircraft and may not reflect the actual conditions at the time of takeoff. Moreover, the manual process of looking up multiple values and tables can increase the chances of an error in the process.

### BRIEF DESCRIPTION

Disclosed is a system of an aircraft that includes one or more gas turbine engines and a controller. The controller is configured to detect a pre-takeoff condition of the aircraft and determine one or more control parameters for one or more current conditions at a target location of the aircraft. The controller is further configured to determine a final takeoff speed of the one or more gas turbine engines based on the one or more control parameters. At least one of the one or more gas turbine engines is controlled to accelerate to the final takeoff speed after transitioning from the pre-takeoff condition to a takeoff condition.

In addition to one or more of the features described above or below, or as an alternative, further embodiments may include where the controller is configured to determine the one or more control parameters based at least in part on a corrected runway length at the target location and a corrected aircraft weight.

In addition to one or more of the features described above or below, or as an alternative, further embodiments may include where the controller is configured to determine a flexible temperature value based on the corrected runway length at the target location, the corrected aircraft weight, a takeoff configuration of the aircraft, a pressure altitude, and an outside air temperature.

In addition to one or more of the features described above or below, or as an alternative, further embodiments may include where the controller is configured to determine the final takeoff speed as an engine rotational speed based on the flexible temperature value.

In addition to one or more of the features described above or below, or as an alternative, further embodiments may include where the controller is configured to determine the final takeoff speed of the one or more gas turbine engines based at least in part on one or more preferences stored in a memory system.

In addition to one or more of the features described above or below, or as an alternative, further embodiments may include where the controller is configured to determine the final takeoff speed of the one or more gas turbine engines based at least in part on an aircraft state that identifies one or more current conditions of the aircraft that impact takeoff performance of the aircraft.

In addition to one or more of the features described above or below, or as an alternative, further embodiments may include where the controller is configured to receive a cross-compare final takeoff speed from another controller of the aircraft and compare the cross-compare final takeoff speed to a locally computed version of the final takeoff speed.

In addition to one or more of the features described above or below, or as an alternative, further embodiments may include where the controller is configured to determine whether the cross-compare final takeoff speed and the locally computed version of the final takeoff speed are within a comparison threshold, and select a larger value of the cross-compare final takeoff speed and the locally computed version of the final takeoff speed as the final takeoff speed based on determining that the cross-compare final takeoff speed and the locally computed version of the final takeoff speed are within the comparison threshold.

In addition to one or more of the features described above or below, or as an alternative, further embodiments may include where the controller is configured to output a warning indicator based on determining that the cross-compare final takeoff speed and the locally computed version of the final takeoff speed are outside of the comparison threshold.

In addition to one or more of the features described above or below, or as an alternative, further embodiments may include where the controller is configured to monitor the one or more control parameters prior to takeoff of the aircraft, determine an updated final takeoff speed associated with at least one change to the one or more control parameters, and output a warning indicator based on determining that the updated final takeoff speed has changed beyond a change threshold with respect to the final takeoff speed.

Also disclosed is a method that includes detecting, by a control system of an aircraft, a pre-takeoff mode of the aircraft. The control system can determine one or more control parameters for one or more current conditions at a target location of the aircraft. The control system can determine a final takeoff speed of the one or more gas turbine engines based on the one or more control parameters. The control system can control the one or more gas turbine engines to accelerate to the final takeoff speed after transitioning from the pre-takeoff condition to a takeoff condition.

In addition to one or more of the features described above or below, or as an alternative, further embodiments may include determining the one or more control parameters based at least in part on a corrected runway length at the target location and a corrected aircraft weight.

In addition to one or more of the features described above or below, or as an alternative, further embodiments may include determining a flexible temperature value based on the corrected runway length at the target location, the corrected aircraft weight, a takeoff configuration of the aircraft, a pressure altitude, and an outside air temperature.

In addition to one or more of the features described above or below, or as an alternative, further embodiments may include determining the final takeoff speed as an engine rotational speed based on the flexible temperature value.

In addition to one or more of the features described above or below, or as an alternative, further embodiments may include determining the final takeoff speed of the one or more gas turbine engines based at least in part on one or more preferences stored in a memory system.

In addition to one or more of the features described above or below, or as an alternative, further embodiments may include determining the final takeoff speed of the one or more gas turbine engines based at least in part on an aircraft state that identifies one or more current conditions of the aircraft that impact takeoff performance of the aircraft.

In addition to one or more of the features described above or below, or as an alternative, further embodiments may include receiving a cross-compare final takeoff speed from another controller of the aircraft and comparing the cross-compare final takeoff speed to a locally computed version of the final takeoff speed.

In addition to one or more of the features described above or below, or as an alternative, further embodiments may include determining whether the cross-compare final takeoff speed and the locally computed version of the final takeoff speed are within a comparison threshold, and selecting a larger value of the cross-compare final takeoff speed and the locally computed version of the final takeoff speed as the final takeoff speed based on determining that the cross-compare final takeoff speed and the locally computed version of the final takeoff speed are within the comparison threshold.

In addition to one or more of the features described above or below, or as an alternative, further embodiments may include outputting a warning indicator based on determining that the cross-compare final takeoff speed and the locally computed version of the final takeoff speed are outside of the comparison threshold.

In addition to one or more of the features described above or below, or as an alternative, further embodiments may include monitoring the one or more control parameters prior to takeoff of the aircraft, determining an updated final takeoff speed associated with at least one change to the one or more control parameters, and outputting a warning indicator based on determining that the updated final takeoff speed has changed beyond a change threshold with respect to the final takeoff speed.

### BRIEF DESCRIPTION OF THE DRAWINGS

The following descriptions should not be considered limiting in any way. With reference to the accompanying drawings, like elements are numbered alike:

FIG. 1 is a schematic diagram of an aircraft, in accordance with an embodiment of the disclosure;

FIG. 2 is a schematic diagram of a control system, in accordance with an embodiment of the disclosure;

FIG. 3 is a data flow diagram, in accordance with an embodiment of the disclosure;

FIG. 4 is an aircraft takeoff plot in accordance with an embodiment of the disclosure;

FIG. 5 is an aircraft takeoff decision plot in accordance with an embodiment of the disclosure; and

FIG. 6 is a flow chart illustrating a method, in accordance with an embodiment of the disclosure.

### DETAILED DESCRIPTION

A detailed description of one or more embodiments of the disclosed apparatus and method are presented herein by way of exemplification and not limitation with reference to the Figures.

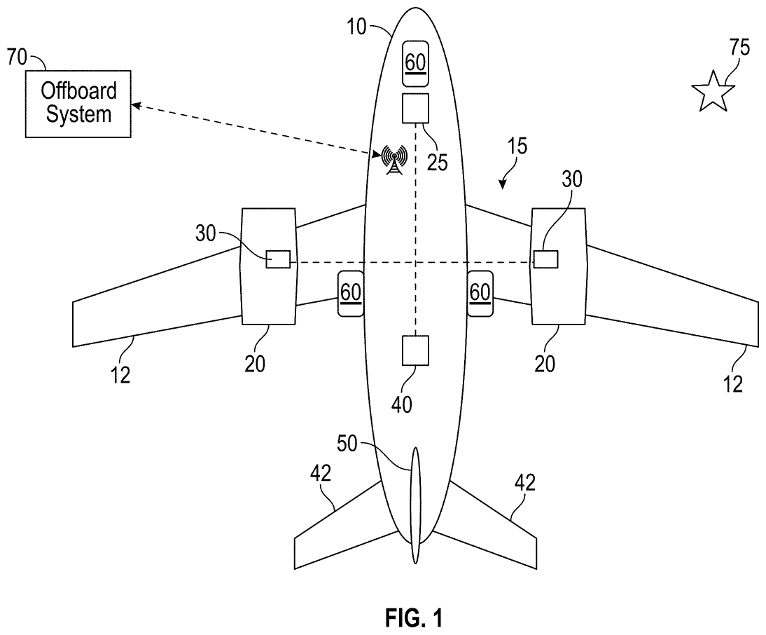

FIG. 1 schematically illustrates an aircraft 10 that includes a pair of gas turbine engines 20. The aircraft 10 also includes wheels 60 that allow for ground-based movement and steering of the aircraft 10. Embodiments of the present disclosure compute a final takeoff speed of the aircraft 10 and control operation of the gas turbine engines 20 to accelerate to the final takeoff speed. Rather than a pilot or co-pilot manually determining the final takeoff speed by referencing many sources and lookup tables, controllers 30 and/or a flight management system 40 can be used to determine the final takeoff speed, thus reducing pilot/co-pilot burden, increasing accuracy, and allowing for subsequent condition checks to verify the final takeoff speed determination.

In embodiments, a control system 15 can be distributed throughout the aircraft 10. For example, the control system 15 can include pilot controls 25, controllers 30, and flight management system 40. The controllers 30 can be located in close proximity to the gas turbine engines 20, such as integrated with a full authority digital engine control of each of the gas turbine engines 20 or can be located elsewhere within the aircraft 10. The pilot controls 25 can control multiple aspects of the aircraft 10, such as controlling flight surfaces (e.g., slats/flaps) on wings 12, tail 42, and rudder 50 of the aircraft 10. The pilot controls 25 can transmit commands and receive status from components of the aircraft 10, including the controllers 30, flight management system 40, and other such components. The pilot controls 25 and/or the flight management system 40 can also communicate with offboard systems 70, for instance, using wireless/radio frequency transmission. The offboard systems 70 may provide status information associated with runways, taxiways, weather conditions, and other such information to assist with navigating the aircraft 10 to/from a target location 75, such as a gate, taxiway, and runway of an airport. For example, weather conditions, such as rain, ice, sleet, snow, high winds, and the like may be used in determining runway conditions that can reduce traction and the effectiveness of speed modification and directional control of the aircraft 10. Effective length computations can be adjusted according to one or more functions and/or lookup tables that characterize the effects of various weather conditions.

The pilot controls 25 can provide manual control interfaces for features such as throttle settings, control surface settings, and the like. In embodiments of the disclosure, the control system 15 is configured to automatically determine the final takeoff speed of each gas turbine engine 20 using the processes as further disclosed herein. The automated control can be managed by either or both of the controllers 30 and/or by the flight management system 40.

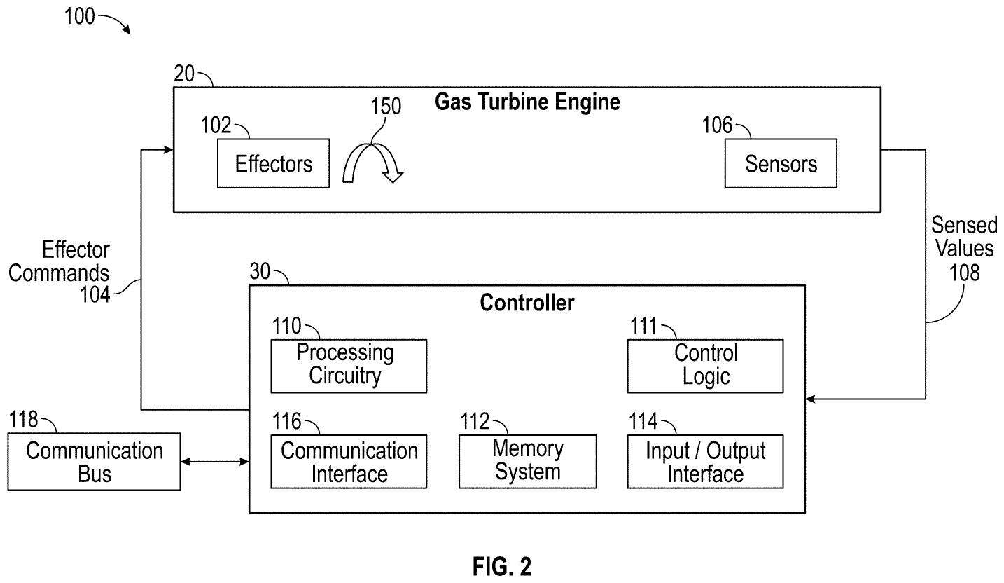

FIG. 2 illustrates a control system 100 as an example of a portion of the control system 15 of FIG. 1 to control one or more gas turbine engines 20 of the aircraft 10 of FIG. 1. The gas turbine engine 20 can be controlled through adjusting one or more effectors 102 by one or more effector commands 104 output from controller 30. The controller 30 can be implemented as dedicated or distributed control between multiple components. Examples of effectors 102 can include one or more motors, solenoids, valves, relays, pumps, heaters, and/or other such actuation control components. A plurality of sensors 106 can capture state data associated with the gas turbine engine 20 and/or aircraft 10 and provide sensed values 108 as feedback to the controller 30 to enable closed-loop control according to one or more control laws. Examples of the sensors 106 can include one or more temperature sensors, pressure sensors, strain gauges, switches, position sensors, speed sensors, accelerometers, lube sensors, and the like. As one example, the controller 30 can be a full authority digital engine control.

The controller 30 can include processing circuitry 110 and a memory system 112 configured to store a plurality of configuration items, where at least one of the configuration items includes a sequence of the computer executable instructions for execution by the processing circuitry 110. Other types of configuration items can include but are not limited to data, such as constants, configurable data, and/or fault data. Examples of computer executable instructions can include boot software, operating system software, and/or application software. The executable instructions may be stored or organized in any manner and at any level of abstraction, such as in connection with controlling and/or monitoring operation of the aircraft component 101. The processing circuitry 110 can be any type or combination of central processing unit (CPU), including one or more of: a microprocessor, a digital signal processor (DSP), a microcontroller, an application specific integrated circuit (ASIC), a field programmable gate array (FPGA), or the like. Also, in embodiments, the memory system 112 may include volatile memory, such as random access memory (RAM), and non-volatile memory, such as Flash memory, read only memory (ROM), and/or other electronic, optical, magnetic, or any other computer readable medium onto which is stored data and algorithms in a non-transitory form.

The controller 30 can also include one or more of an input/output interface 114, a communication interface 116, and/or other elements (not depicted). The input/output interface 114 can include support circuitry for interfacing with the effectors 102 and sensors 106, such as filters, amplifiers, digital-to-analog converters, analog-to-digital converters, and other such circuits to support digital and/or analog interfaces. Further, the input/output interface 114 can receive or output signals to/from other sources. The communication interface 116 can be communicatively coupled to other controllers and/or systems through a communication bus 118. For example, the communication bus 118 can interface with the pilot controls 25 and/or flight management system 40 of FIG. 1. The communication bus 118 may receive and provide aircraft-level parameters and commands that are used by the controller 30 to control the gas turbine engine 20 in real-time.

In some embodiments, the controller 30 can be part of an aircraft-level control or be distributed between one or more systems of the aircraft 10 of FIG. 1. For example, a portion of the controller 30 can be implemented within the flight management system 40 of FIG. 1 or integrated with other such systems of the aircraft 10. Control logic 111 of the controller 30 can be implemented in a combination of circuits and/or executable instructions for execution by the processing circuitry 110 to control effectors 102, for instance, based on various modes, parameters, and models. Control laws implemented by the control logic 111 can be selected and executed depending on whether the aircraft 10 is in a pre-takeoff taxi, takeoff, climb, cruise, descent, landing, or post-landing taxi mode, or other such operating modes, for example. Other special case modes of operation can be entered into based on failure conditions. The operating mode can be determined based on tracking various parameters, such as weight-on-wheels, altitude, velocity, and other such aircraft parameters.

The controller 30 can apply control laws and access/update models to determine how to control the gas turbine engine 20. For example, sensed and/or derived parameters related to speed, flow rate, pressure ratios, temperature, thrust, and the like can be used to establish operational schedules and limits to maintain efficient operation of the gas turbine engines 20 and other components of the aircraft 10 of FIG. 1. For instance, the operating mode of the gas turbine engines 20 can have different power settings, thrust requirements, flow requirements, and temperature effects. With respect to the gas turbine engine 20, a rotational speed 150 can be associated with one or more components, such as a fan or low spool compressor used to provide propulsion during takeoff. The final takeoff speed determined by the control logic 111 of the controller 30 can be a targeted value of the rotational speed 150 to be reached during takeoff of the aircraft 10.

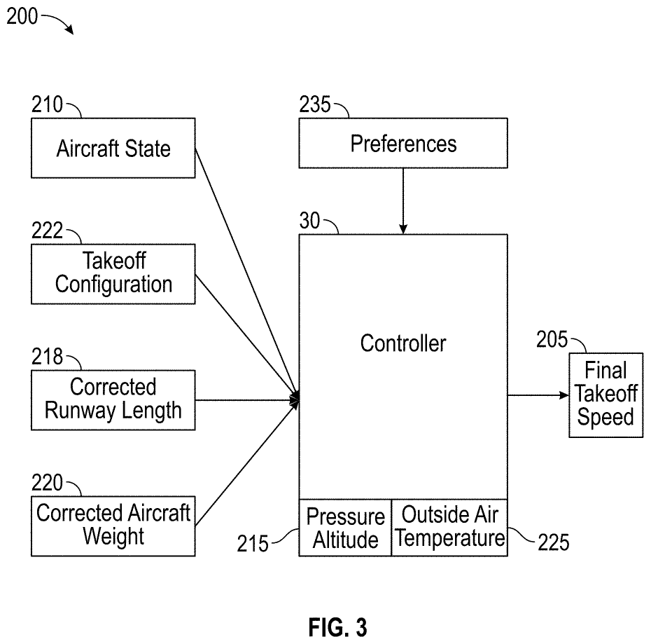

FIG. 3 is a data flow diagram 200 of a controller 30 that determines a final takeoff speed 205 of one or more of the gas turbine engines 20 of the aircraft 10 of FIG. 1. The controller 30 can use a variety of inputs to determine the final takeoff speed 205. Some parameters can be received from external sources (e.g., offboard systems 70 of FIG. 1) and/or be computed by the flight management system 40 of FIG. 1, such a corrected runway length 218 and a corrected aircraft weight 220. Factors such as weather conditions can be incorporated into one or more of the parameters, such as corrected runway length 218, or may be considered as direct parameters. A takeoff configuration 222 can indicate how the aircraft 10 of FIG. 1 is intended to be configured or is currently configured during a takeoff operation, such as slat/flap settings. An aircraft state 210 can indicate current aircraft conditions, such as any existing faults, maintenance warnings, or other information that may impact the final takeoff speed 205. As one example, the flight management system 40 of FIG. 1 can determine the corrected runway length 218 or provide at least a portion of the parameters needed to compute the corrected runway length 218. For instance, wind speed and direction, length of a targeted runway, slope, and/or weather information can be used to determine the corrected runway length 218. The wind speed and direction can include headwind, tailwind, or crosswind. The corrected aircraft weight 220 can be computed based on a known aircraft weight, passenger loading, luggage/cargo, fuel level, and factors at the target location 75, such as pressure altitude 215 and outside air temperature 225. The pressure altitude 215 and outside air temperature 225 can be locally computed and cross verified with at least one other system component. Values of the corrected runway length 218 and/or corrected aircraft weight 220 can be presented through the pilot controls 25 to allow for pilot verification before confirming the final takeoff speed 205 determined using these inputs.

The controller 30 can also use preferences 235, for instance, as stored in non-volatile memory of the memory system 112 of FIG. 2 to further customize the determination of the final takeoff speed 205. For example, airlines may have separate preferences for climb rate and fuel burn rate that may differ and result in variations to the final takeoff speed 205. Depending upon the parameters used, the determination of the final takeoff speed 205 can use a combination of multi-variate lookup tables or other techniques. For instance, a nominal value of the final takeoff speed 205 may be adjusted higher or lower as the combination of parameters are considered. As one example, an optimizing control function can be used to determine how changes to the final takeoff speed 205 should be made in view of current operating conditions and constraints such as preferences for climb rate and fuel burn rate.

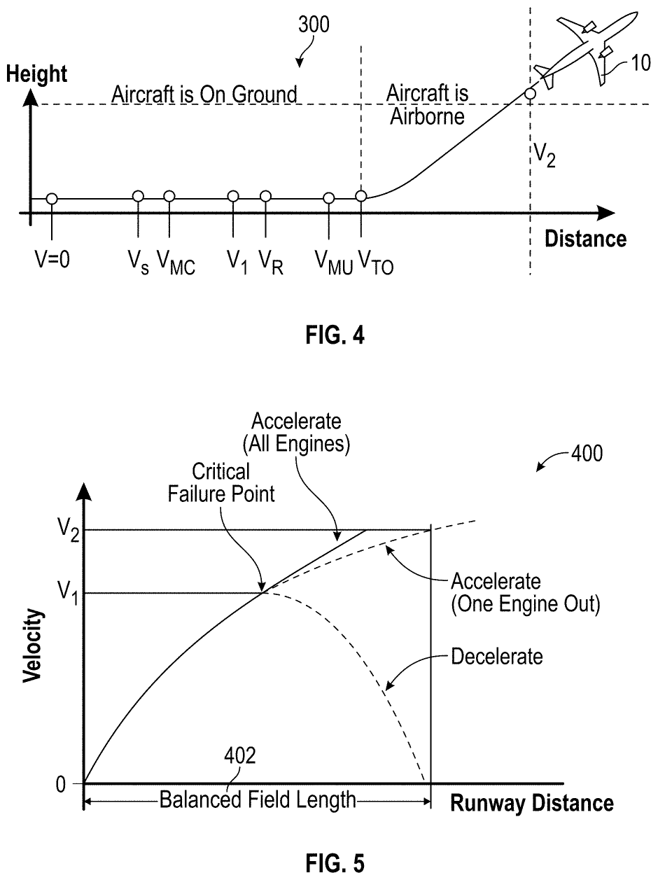

FIGS. 4 and 5 illustrate examples of an aircraft takeoff plot 300 and an aircraft takeoff decision plot 400. The aircraft takeoff plot 300 and the aircraft takeoff decision plot 400 can be used for thrust control decisions by the controller 30 of FIG. 1 in combination with other data sources. An aircraft, such as aircraft 10, can initiate a takeoff from zero velocity (V=0) until a takeoff speed (V_{TO}) is reached after traveling a distance along a runway. Various relative velocities encountered during a normal takeoff can be defined for a takeoff process. The aircraft 10 accelerates through a stall speed (V_{S}), a minimum controllable speed (V_{MC}), a decision speed (V₁) where safe stopping can still be achieved on the ground, a rotation speed (V_{R}) where the nose of the aircraft 10 is pitched up, a minimum unstick speed for the tail to clear the runway at maximum rotation, and a takeoff end speed (V₂) where sufficient altitude is acquired. The final takeoff speed 205 of FIG. 3 can represent the engine rotational speed needed for the aircraft 10 to reach the takeoff speed (V_{TO}). If a propulsion system failure occurs above the decision speed (V₁), then takeoff continues. At the decision speed (V₁), the distance required to stop may be substantially equal to the distance required to takeoff. A balanced field length 402 can be defined as a distance needed to reach the decision speed (V₁) and safely stop if a takeoff is aborted at the decision speed (V₁). These factors can be used to determine takeoff thrust settings for the gas turbine engines 20 of FIG. 1.

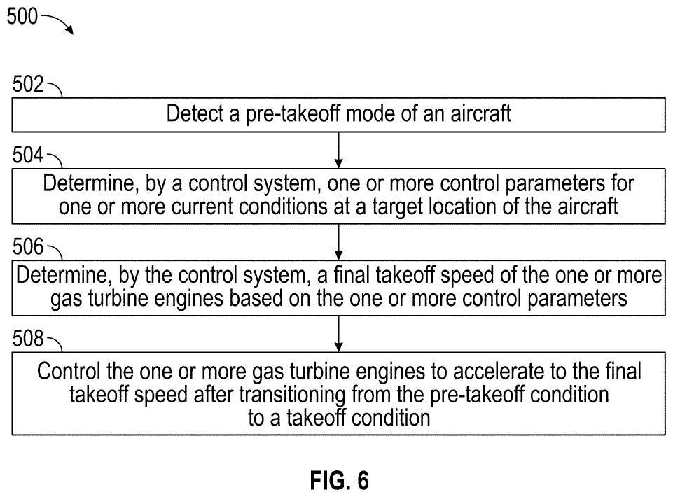

Referring now to FIG. 6 with continued reference to FIGS. 1-5, FIG. 6 is a flow chart illustrating a method 500 for determining a final takeoff speed 205 for aircraft 10 in accordance with an embodiment. The method 500 may be performed, for example, by the aircraft 10 through the control system 15 of FIG. 1 and/or the control system 100 of FIG. 2. For purposes of explanation, the method 500 is described primarily with respect to the controller 30; however, it will be understood that the method 500 can be performed on other configurations.

Method 500 pertains to the controller 30 executing embedded code for final takeoff speed determination and propulsion control, where the controller 30 can be an engine control, an aircraft-level control, or distributed between aircraft and propulsion system levels of control. At block 502, the controller 30 detects a pre-takeoff mode of the aircraft 10. The pre-takeoff mode can be detected when the aircraft 10 is at a gate before pushback, after pushback, or upon engine start, for example. Generally, pre-takeoff mode can cover any time before setting a throttle of the aircraft 10 to a takeoff level.

At block 504, the controller 30 determines one or more control parameters for one or more current conditions at a target location 75 of the aircraft 10. The one or more control parameters can be determined based at least in part on a corrected runway length 218 at the target location 75 and a corrected aircraft weight 220 of the aircraft 10. The controller 30 can be configured to determine a flexible temperature value based on the corrected runway length 218 at the target location 75, the corrected aircraft weight 220 of the aircraft 10, a takeoff configuration 222 of the aircraft 10, a pressure altitude 215, and an outside air temperature 225. The flexible temperature value can be a modified temperature that differs from the outside air temperature 225 to change a targeted thrust setting, where a higher flexible temperature may be associated with a reduced targeted thrust setting. A combination of multivariate tables with interpolation can be used, for example, that relate the parameters to each other. Factors that can reduce or eliminate modifications to the flexible temperature value can include factors that may involve safety, such as a shorter stopping distance due to runway length or surface condition, a higher altitude airport location, and other such considerations.

At block 506, the controller 30 determines a final takeoff speed 205 of the one or more gas turbine engines 20 based on the one or more control parameters. The controller 30 can be configured to determine the final takeoff speed 205 as an engine rotational speed 150 based on the flexible temperature value. The controller 30 can be configured to determine the final takeoff speed 205 of the one or more gas turbine engines 20 based at least in part on one or more preferences 235 stored in a memory system 112.

The controller 30 can also be configured to determine the final takeoff speed 205 of the one or more gas turbine engines 20 based at least in part on an aircraft state 210 that identifies one or more current conditions of the aircraft 10 that impact takeoff performance of the aircraft 10. As one example, the controller 30 can receive a cross-compare final takeoff speed from another controller of the aircraft 10 and compare the cross-compare final takeoff speed to a locally computed version of the final takeoff speed 205. The controller 30 can determine whether the cross-compare final takeoff speed and the locally computed version of the final takeoff speed 205 are within a comparison threshold. The controller 30 can select a larger value of the cross-compare final takeoff speed and the locally computed version of the final takeoff speed 205 as the final takeoff speed 205 based on determining that the cross-compare final takeoff speed and the locally computed version of the final takeoff speed 205 are within the comparison threshold. The controller 30 can output a warning indicator based on determining that the cross-compare final takeoff speed and the locally computed version of the final takeoff speed 205 are outside of the comparison threshold.

At block 508, the controller 30 controls at least one of the one or more gas turbine engines 20 to accelerate to the final takeoff speed 205 after transitioning from the pre-takeoff condition to a takeoff condition. The controller 30 can monitor the one or more control parameters prior to takeoff of the aircraft 10. The controller 30 can determine an updated final takeoff speed associated with at least one change to the one or more control parameters. The controller 30 can output a warning indicator based on determining that the updated final takeoff speed has changed beyond a change threshold with respect to the final takeoff speed 205. For example, the warning can allow the pilot or co-pilot to switch to the updated final takeoff speed upon concluding that the updated final takeoff speed is preferred over the previous determination of the final takeoff speed 205.

While the above description has described the flow process of FIG. 6 in a particular order, it should be appreciated that unless otherwise specifically required in the attached claims that the ordering of the steps may be varied. Also, it is clear to one of ordinary skill in the art that, the thrust reverser control and braking described herein can be combined with aircraft and propulsion system control features, such as fuel flow control, power management, emergency operation, and the like.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system of an aircraft, the system comprising:
one or more gas turbine engines; and
a controller configured to:
detect a pre-takeoff condition of the aircraft;
determine one or more control parameters for one or more current conditions at a target location of the aircraft;
determine a final takeoff speed of the one or more gas turbine engines based on the one or more control parameters; and
control at least one of the one or more gas turbine engines to accelerate to the final takeoff speed after transitioning from the pre-takeoff condition to a takeoff condition.

2. The system of claim 1, wherein the controller is configured to determine the one or more control parameters based at least in part on a corrected runway length at the target location and a corrected aircraft weight.

3. The system of claim 2, wherein the controller is configured to determine a flexible temperature value based on the corrected runway length at the target location, the corrected aircraft weight, a takeoff configuration of the aircraft, a pressure altitude, and an outside air temperature.

4. The system of claim 3, wherein the controller is configured to determine the final takeoff speed as an engine rotational speed based on the flexible temperature value.

5. The system of claim 1, wherein the controller is configured to determine the final takeoff speed of the one or more gas turbine engines based at least in part on one or more preferences stored in a memory system.

6. The system of claim 1, wherein the controller is configured to determine the final takeoff speed of the one or more gas turbine engines based at least in part on an aircraft state that identifies one or more current conditions of the aircraft that impact takeoff performance of the aircraft.

7. The system of claim 1, wherein the controller is configured to:
receive a cross-compare final takeoff speed from another controller of the aircraft; and
compare the cross-compare final takeoff speed to a locally computed version of the final takeoff speed.

8. The system of claim 7, wherein the controller is configured to:
determine whether the cross-compare final takeoff speed and the locally computed version of the final takeoff speed are within a comparison threshold; and
select a larger value of the cross-compare final takeoff speed and the locally computed version of the final takeoff speed as the final takeoff speed based on determining that the cross-compare final takeoff speed and the locally computed version of the final takeoff speed are within the comparison threshold.

9. The system of claim 8, wherein the controller is configured to output a warning indicator based on determining that the cross-compare final takeoff speed and the locally computed version of the final takeoff speed are outside of the comparison threshold.

10. The system of claim 1, wherein the controller is configured to:
monitor the one or more control parameters prior to takeoff of the aircraft;
determine an updated final takeoff speed associated with at least one change to the one or more control parameters; and
output a warning indicator based on determining that the updated final takeoff speed has changed beyond a change threshold with respect to the final takeoff speed.

11. A method comprising:
detecting, by a control system of an aircraft, a pre-takeoff condition of the aircraft;
determining, by the control system, one or more control parameters for one or more current conditions at a target location of the aircraft;
determining, by the control system, a final takeoff speed of the one or more gas turbine engines based on the one or more control parameters; and
controlling, by the control system, the one or more gas turbine engines to accelerate to the final takeoff speed after transitioning from the pre-takeoff condition to a takeoff condition.

12. The method of claim 11, further comprising:
determining the one or more control parameters based at least in part on a corrected runway length at the target location and a corrected aircraft weight.

13. The method of claim 12, further comprising:
determining a flexible temperature value based on the corrected runway length at the target location, the corrected aircraft weight, a takeoff configuration of the aircraft, a pressure altitude, and an outside air temperature.

14. The method of claim 13, further comprising:
determining the final takeoff speed as an engine rotational speed based on the flexible temperature value.

15. The method of claim 11, further comprising:
determining the final takeoff speed of the one or more gas turbine engines based at least in part on one or more preferences stored in a memory system.

16. The method of claim 11, further comprising:
determining the final takeoff speed of the one or more gas turbine engines based at least in part on an aircraft state that identifies one or more current conditions of the aircraft that impact takeoff performance of the aircraft.

17. The method of claim 11, further comprising:
receiving a cross-compare final takeoff speed from another controller of the aircraft; and
comparing the cross-compare final takeoff speed to a locally computed version of the final takeoff speed.

18. The method of claim 17, further comprising:
determining whether the cross-compare final takeoff speed and the locally computed version of the final takeoff speed are within a comparison threshold; and
selecting a larger value of the cross-compare final takeoff speed and the locally computed version of the final takeoff speed as the final takeoff speed based on determining that the cross-compare final takeoff speed and the locally computed version of the final takeoff speed are within the comparison threshold.

19. The method of claim 18, further comprising:
outputting a warning indicator based on determining that the cross-compare final takeoff speed and the locally computed version of the final takeoff speed are outside of the comparison threshold.

20. The method of claim 11, further comprising:
monitoring the one or more control parameters prior to takeoff of the aircraft;
determining an updated final takeoff speed associated with at least one change to the one or more control parameters; and
outputting a warning indicator based on determining that the updated final takeoff speed has changed beyond a change threshold with respect to the final takeoff speed.
